(19) United States
(12) Patent Application Publication
(10) Pub. No.: US 2003/0065058 A1
(43) Pub. Date: Apr. 3, 2003

(54) Method and use of incorporating water soluble or water dispersible polymer(s) into a metalworking emulsifiable concentrate to form a stable metalworking emulsifiable concentrate and end use emulsion

(76) Inventors: Carlos A. Piedrahita, Mentor, OH (US); Ping Y. Zhu, Solon, OH (US)

Correspondence Address: Teresan W. Gilbert, The Lubrizol Corporation, Patent Dept.-Mail Drop 022B, 29400 Lakeland Boulevard, Wickliffe, OH, 44092-2298, US

(21) Appl. No.: 10/246,579

(22) Filed: Sep. 18, 2002

Related U.S. Application Data
(63) Continuation of application No. 09/383,349, filed on Aug. 26, 1999, now abandoned.

(51) Int. Cl. C08J 3/00; C10M 101/00

(52) U.S. Cl. 523/336; 508/110

(57) ABSTRACT

The present invention provides a method and use of incorporating water soluble or water dispersible polymer(s), stabilized in an invert (water-in-oil) emulsion, into an oil continuous metalworking emulsifiable concentrate, which is then diluted with water to form an end use oil-in-water emulsion. According to the present invention, the invert polymer emulsion (A) is added to the metalworking emulsifiable concentrate (B) to embed at least one water soluble or water dispersible polymer into the metalworking emulsifiable concentrate, to form a stable, emulsifiable concentrate (C). The stable, emulsifiable concentrate (C) is then diluted with water to form an end use oil-in-water emulsion (D) causing the water soluble or water dispersible polymer in the end use emulsion to impart antimist performance.

### FIELD OF THE INVENTION

The present invention is directed to a method of incorporating water soluble or water dispersible polymer(s) into a metalworking emulsifiable concentrate, which forms a stable metalworking emulsifiable concentrate used to form an end-use emulsion, and obtaining mist suppression performance from the water soluble or water dispersible polymer(s) present in the end use emulsion prepared from the metalworking emulsifiable concentrate.

### BACKGROUND OF THE INVENTION

Mists generated by metalworking fluids (MWF) during production operations have been identified as a health, fire and safety hazard. Due to concerns related to worker exposure to the MWF mists, it is expected that OSHA/EPA will lower the current permissible exposure limit (PEL) from a current PEL of 5 mg/m³ to 0.5 mg/m³.

One of the known methods of suppressing mist generation during metalworking operations is based on adding water soluble or dispersible polymers as antimist (mist suppressing) additives to the MWFs. In the past, these antimist polymers are added as top treats to the end-use MWFs as aqueous solutions or slurries via tank side additions.

This method which is based on top treating the MWF with an antimist polymer poses logistical problems during the application and maintenance of the antimist polymers in the MWF. Until now, it has not been possible to incorporate water soluble or water dispersible polymers in oil continuous metalworking emulsifiable concentrates, especially in a soluble oil concentrate. This is because the water soluble or water dispersible polymers are not compatible with the oil continuous concentrates. This incompatibility has resulted in concentrate instability (polymer dropout, phase separation, gellation, haziness, etc.).

This invention solves these problems by providing a method of successfully incorporating a water soluble or water dispersible polymer into a metalworking emulsifiable concentrate by using an invert (water in oil) emulsion containing a water soluble or water dispersible polymer in the dispersed aqueous phase, to embed the polymer into the metalworking emulsifiable concentrate. The emulsifiable concentrate containing the embedded water soluble or water dispersible polymer is then diluted with water, prior to use, to form an end use oil-in-water emulsion containing the water soluble or water dispersible polymer. The end use oil-in-water emulsion of the present invention contains at least one water soluble or water dispersible polymer, which functions as an antimist polymer, and a metalworking emulsifiable concentrate.

### SUMMARY OF THE INVENTION

The present invention provides a method and use of incorporating water soluble or water dispersible polymer(s), stabilized in an invert (water-in-oil) emulsion, into an oil continuous metalworking emulsifiable concentrate, which is diluted with water, to form the end use oil-in-water emulsion. According to the present invention, the invert polymer emulsion (A) is added to the metalworking emulsifiable concentrate (B) to embed at least one water soluble or water dispersible polymer into the metalworking emulsifiable concentrate to form an antimist emulsifiable concentrate (C). The emulsifiable concentrate (C) is then diluted with water to form an end use oil-in-water emulsion (D) causing the water soluble or water dispersible polymer in the end use emulsion to impart antimist performance. The purpose of the water soluble or water dispersible polymer is to function as an antimist polymer.

### BRIEF DESCRIPTION OF THE DRAWING

FIG. 1 is a schematic of the grinder antimist test.

### DETAILED DESCRIPTION OF THE INVENTION

(A) Water Soluble or Water Dispersible Polymer(s) Stabilized in an Invert (Water-in-Oil) Emulsion

The invert polymer emulsion, commonly referred to in the art as a polymer invert, or invert aqueous polymer emulsion, is a colloidal dispersion of water swollen polymer particles in a continuous organic medium, for example, oil or mineral spirits. This emulsion consists of a dispersed phase (water) containing the water soluble or water dispersible polymer, stabilized in an organic medium (oil) by using at least one surfactant.

The water soluble or dispersible polymers useful in the present invention include at least one of homopolymers, copolymers and higher inter-polymers of any combination of monomers which are at least partially soluble in water. A combination or combinations of at least one of such homopolymers, copolymers and higher inter-polymers can also be used. The phrase “higher inter-polymers” as used throughout this specification means polymers containing 3 or more different monomers described hereinafter. Descriptions of useful monomers are set forth in U.S. Pat. No. 4,419,466, incorporated herein by reference in its entirety.

Suitable monomers include acrylamide, methacrylamide, acrylic acid, methacrylic acid, maleic acid, maleic anhydride, fumaric acid, crotonic acid, styrene sulfonic acid, 2-acrylamido-2-methylpropanesulfonic acid, 3-acrylamido-3-methylbutyl-trimethylammonium chloride, 2-acrylamido-2-methylpropyl trimethylammonium chloride, 2-methacryloyloxyethyl trimethylammonium methosulfate, 3-methacryloyl-2-hydroxypropyl trimethylammonium chloride, dimethyldiallyl-ammonium chloride, diethyldiallylammonium chloride, itaconic acid, vinyl acetate, 3-acrylamido-3-methylbutanoic acid, polyethyleneglycol monomethacrylate, 2-acrylamido-2-methyl-propanephosphonic acid or an amine or metal salt thereof, and N-vinylpyrrolidone. An amine or metal salt of any of the aforementioned acids are also suitable for the present invention.

Also included are acrylic acid derivatives such as esters of acrylic acids, amine or metal salts of acrylic acids, acrylic amides, and acrylonitriles and the corresponding alkacryl-, especially methacryl-, compounds. The esters of acrylic acids typically contain from 1 to about 50 carbon atoms in the ester group. The number of carbon atoms in the ester group is defined as the number of carbon atoms in the group attached to the oxygen. The alkyl group is derived from the alcohol from which the ester is made. Often, the ester groups are lower alkyl esters wherein the expression “lower alkyl” means alkyl groups having fewer than 8 carbon atoms, preferably from 1 to about 4 carbon atoms. Further examples of acrylic acid derivatives include methacrylic acid, esters thereof, including lower alkyl esters, fatty esters, polyethyleneglycol esters, and mixed esters, such as C8-10 alkyl esters and C12-15 esters, and N- and N,N-substituted acrylamides, and the corresponding methacrylamides, acrylonitrile, and methacrylonitrile. In a suitable amide useful in the present invention, the number of carbon atoms in the groups attached to the N is from 1 to about 36 carbon atoms, or from 1 to about 8 carbon atoms. Also included among acrylic monomers are (α,β-unsaturated polycarboxylic monomers such as maleic acid, esters thereof, amides, amidic acids and esters thereof, and the corresponding fumaric compounds.

The monomer can also be a sulfonic acid or an amine or metal salt thereof. Suitable polymerizable sulfonic acids include acrylamidoalkane sulfonic acids, as well as such monomers as styrenesulfonic acid (mentioned above), vinylsulfonic acid, allylsulfonic acid, and methallylsulfonic acid. The monomer can also be a sulfoalkyl ester such as 2-sulfoethylmethacrylate, 3-sulfopropyl acrylate, or 3-sulfopropylmethacrylate.

Also included are phosphonic acids or their amine, metal salts or esters thereof, such as phosphonomethylacrylate, phosphonomethyl methacrylate, vinyl phosphonic acid, and allyl phosphonic acid.

In another embodiment of the present invention, after the selection of monomers as set forth above is determined, at least one additional, optional monomer can be used in combination with the selection of monomers set forth above. This optional monomer can include vinyl aromatic monomers, defined as monomers in which an aromatic group includes one or more vinyl groups as substituents, which, in its narrowest sense, refers specifically to a CH2═CH— group, although homologues in which one or more of the hydrogen atoms is replaced by another group such as a lower alkyl group are included in the general term “vinyl.” Other monomers include polymerizable olefin monomers, including those of 2 to 16 carbon atoms. The olefins can be monoolefins such as ethylene, propylene, 1-butene, isobutene, and 1-octene, or polyolefinic monomers, preferably diolefinic monomers such as 1,3-butadiene or isoprene. Also included are esters such as dialkyl fumarates, and dialkyl maleates, and their corresponding half esters, and maleamic esters, maleimides, vinyl esters of C₁ to C₁₂ carboxylic acids, and allyl carboxylates. The phrase “optional monomer” used in this paragraph means that at least one of the monomers recited in this paragraph can be used in addition to and in combination with the selection of monomers mentioned in the preceding paragraphs.

The preferred monomers for this invention are acrylamide, methacrylamide and the acrylamidoalkanesulfonic acids and metal salts thereof, especially 2-acrylamido-2-methylpropanesulfonic acid and its salts. Particularly preferred are copolymers of acrylamide and 2-acrylamido-2-methylpropanesulfonic acid or its salts.

A commercially available example of a water soluble or water dispersible polymer useful in the present invention is Nalcotrol®.

The continuous phase in the polymer invert emulsion (A) is typically a non-polar, hydrophobic liquid that is inert to addition polymerization. It is typically mineral oil. However, it may also be another non-polar, hydrophobic liquid such as naphtha, hexane, fuel oil, mineral spirits, benzene, toluene or xylene, provided that it is inert to addition polymerization. A preferred group of non-polar, hydrophobic liquids are the hydrocarbon liquids which include both aromatic and aliphatic compounds. Thus, such organic hydrocarbon liquids as benzene, xylene, toluene, mineral oils, mineral spirits, kerosenes, naphthas and, in certain instances, petrolatums may be used. By “inert” is meant this component does not itself undergo addition polymerization; the use of liquids that may under some conditions serve as chain transfer agents is, however, within the scope of the invention. For example, such otherwise inert hydrocarbons as hexane and toluene are suitable even though they may under some conditions participate in polymerization reactions by serving as chain transfer agents.

Additional components of (A) include stabilizers, such as emulsifiers or surfactants. Emulsifying agents are necessary for the stabilization of invert emulsions. The preferred emulsifying agents are nonionic and include known materials sold under the trade names Igepal®, Tween® and Span®. Many of the suitable emulsifiers are polyoxyethylene condensates; others are fatty acid esters of various polyhydroxy compounds such as sorbitan. A wide variety of free radical sources may be used as initiators for the polymerization reaction including persulfates, redox couples, azo compounds, peroxides, and the like.

The amount of water soluble or water dispersible polymer in the invert polymer emulsion (A), based on the total weight of the invert polymer emulsion (A), ranges from about 0.1 wt % to about 50 wt %. Preferably, the water soluble or water dispersible polymer in the invert polymer emulsion (A) is present in an amount from about 10 wt % to about 35 wt %.

Suitable descriptions of invert emulsion compositions are those set forth in U.S. Pat. Nos. 4,419,466, 3,624,019, 4,525,496, 3,826,771, 4,539,368, 4,022,731, 4,690,996, 4,022,736, 4,727,110, 4,147,681, 4,745,154, 4,524,175 and 4,824,894, incorporated herein by reference in their entirety. Other water-soluble or water-dispersible polymers dispersed in suitable inverts can also be used for this invention provided that the water soluble or water dispersible polymer which is incorporated into the metalworking emulsifiable concentrate functions as an antimist polymer, as measured by the grinder antimist test described after Table 1 in the present specification.

The following Examples 1 and 2 illustrate the preparation of an invert polymer emulsion(s) (A) useful in the present invention.

Example 1 uses a NaAMPS/N′,N′-Methylenebisacrylamide copolymer (30 wt % polymer) as the water-soluble polymer, dispersed in an invert emulsion, made as an experimental product at the Lubrizol Corporation, hereby referred to as LZ Sample #1.

Example 2 uses a NaAMPS/acrylamide copolymer (30 wt % polymer) as the water-soluble polymer dispersed in an invert emulsion, also made as an experimental product at the Lubrizol Corporation, hereby referred to as LZ Sample #2.

EXAMPLE 1

| Item | | Amount | | | |
|---|---|---|---|---|---|
| # | Materials | Grams | | M. Wt. | Moles |
| a. | Odorless Mineral Spirits | 806.0 | | — | — |
| b. | Atlas G1086 ® | 240.2 | | — | — |
| c. | Arlacel 83 ® | 40.8 | | — | — |
| d. | *Lubrizol 2405A | 1393.1 | | 229.2 | 3.52 |
| e. | N,N′-Methylenebis- | 0.51 | | 154.2 | 3.31 × 10⁻³ |
| | acrylamide | | | | |
| f. | H₂O, distilled | 223.2 | | — | — |
| g. | Lupersol 11 ®, diluted | 1.3 | ml | 174 | 4.68 × 10⁻⁴ |
| | (1:10)ᵥ w/odorless mineral | | | | |
| | spirits | | | | |

*Lubrizol 2405A is 2-acrylamido-2-methylpropanesulfonic acid sodium salt (AMPS ®), 58% w aqueous solution

A 3 L resin flask was set-up with a reflux condenser, a thermowell, a stirrer (stainless steel turbines), and a purge tube at subsurface level. The stirrer was attached to a standard overhead mechanical lab stirrer. The stirrer speed was set at approximately 600 rpm.

The resin flask was charged with a, b, and c. After the stirring was initiated, an aqueous solution of d, e and f was added to the stirred resin flask contents. Stirring was continued with a subsurface N₂ purge at 1.2 SCFH. After purging for approximately four hours, item g was added, using a syringe, to the resin flask contents.

The resin flask contents were heated to 48° C. Over the next 94 minutes, the temperature was held at temperatures ranging from 47° C. to 54° C., using a heating mantle. After that initial period, the temperature was held at 49-52° C. for 17.5 hours, at which point, heating was stopped, and the contents were cooled to room temperature. The contents were passed through a fine (60×48) standard paint filter cone to yield 2658.0g of fluid transparent polymer invert emulsion as the product. This product hereafter is referred to as LZ Sample #1.

EXAMPLE 2

| Item # | Materials | Grams | Eq. Wt. | Moles |
|---|---|---|---|---|
| a. | Isopar ® M | 240.0 | — | — |
| b. | Sorbitan monooleate | 19.25 | — | — |
| c. | Tween ® 85 | 5.75 | — | — |
| d. | Acrylamide 50 w % aqueous | 416.6 | 142.2 | 2.93 |
| | solution | | | |
| e. | Lubrizol 2404* | 82.86 | 207 | 0.40 |
| f. | KBrO₃ | 0.15 | — | — |
| g. | EDTA** | 0.25 | — | — |
| h | Demineralized water | 20.0 | — | — |
| i. | Isopropanol | 1.25 | — | — |
| j. | Demineralized water | 151.2 | — | — |
| k. | NaOH (50 w %) | 32.0 | 80 | 0.4 |
| l. | 2,2′-Azobis (2,4-dimethyl | 3 × 0.041 | — | — |
| | valeronitrile) | | | |
| m. | Xylene | 3 × 0.555 | — | — |
| n. | NaMBS*** | 0.25 | — | — |
| o. | Demineralized Water | 0.583 | — | — |

*2-acrylamido-2-methyl propane sulfonic acid (AMPS ®)
**EDTA is ethylenediamine tetracetic acid
***NaMBS is sodium metabisulfite

The organic phase was prepared by adding a, b, and c to a 1 L stainless steel beaker. The contents were stirred until the surfactants dissolved.

The aqueous phase was prepared by mixing j and k in a 1 L glass beaker. This solution was cooled to below 20° C. with an ice bath. To this solution, e was added, portionwise, during which the temperature was controlled to below 20° C.

After all of item e was added, a solution of g in h was added to the beaker, and the pH was adjusted to 7 with the addition of 0.1N NaOH. To the neutralized solution, d, f, and i were added, and the mixture was stirred until all components dissolved.

Emulsification of the 2 phases was conducted as follows. The aqueous phase was added slowly to the organic phase with stirring. The resulting mixture was stirred for 10 minutes before emulsified by agitation using an IKA T-50 ULTRA TURRAX mixer for 1 minute at a mixing rate of 8000 rpm. The emulsion was then placed into a 1 L jacketed resin kettle and purged, while stirring and heating, with ultrapure N₂ at flow rate of 5 scfh for one hour. Stirring continued using a stainless steel 4-bladed propeller (from AOG Glass, Cat. #8094-23) at 750 rpm.

Polymerization was conducted as follows. An initiator solution was made by dissolving item 1 in item m. One third of this initiator was injected solution to the emulsion using a syringe. An increase in temperature from 40° C. to 41.5° C. occurred in about 5 minutes due to an exothermic reaction. The N₂ purge was reduced to 1 scfh, and the temperature was maintained at 40° C.=1° C. for 3 hours. At 3 hours, a second portion of initiator was injected. The temperature increased to 42° C. and was kept at 42° C. for 1 hour. At 4 hours, the last portion of initiator was injected. The temperature was raised to 44° C. and was kept at 44° C. for 1 hour, then raised to 46° C. and kept at 46° C. for 30 minutes, then raised to 48° C. and kept at 48° C. for 30 minutes.

At 6 hours, a solution of n in o was injected. The resulting material was stirred at 55° C. for 1 hour before cooled to room temperature, to obtain the resultant product. This product hereafter is referred to as LZ Sample #2.

(B) The Metalworking Emulsifiable Concentrate

The metalworking emulsifiable concentrate (B) suitable for the present invention is any known metalworking emulsifiable concentrate which can be diluted with water to form the end use oil-in-water emulsions. Soluble oil concentrates are examples of emulsifiable concentrates. Specific, suitable examples are set forth in U.S. Pat. Nos. 3,719,598, 2,999,064, 3,981,808, 4,017,405, 4,022,699, 4,719,029, 4,882,077, and 5,417,869. These patents are incorporated by reference herein in their entirety.

The metalworking emulsifiable concentrate (B) typically is a combination of about 1.0 wt % to about 95 wt % of a base oil, with about 99 wt % to about 5 wt % emulsifiers and other performance additives. The oil used in the emulsifiable concentrate (B) may be petroleum derived or synthetic (non-petroleum), vegetable, or other non-petroleum alternatives.

A preferred metalworking emulsifiable concentrate has from about 10 wt % to about 50 wt % emulsifier package, more preferably, from about 15 wt % to about 20 wt % emulsifier package. Therefore, the preferred amount of oil in the emulsifiable concentrate is from about 90 wt % to about 50 wt %, preferably from about 85 wt % to about 80 wt %, based upon the total weight of the selected metalworking emulsifiable concentrate.

Any combination of emulsifiers may be used to prepare the end use oil in water emulsions of the present invention. Emulsifiers may be single materials or may be mixtures of surfactants. Typical emulsifiers include amine or metal sulfonates and carboxylates, non ionic surfactants, fatty acid salts, salts derived from the reaction product of carboxylic acylating agents, polyols, polyether glycols, polyethers, polyesters and the like. The Kirk Othmer Encyclopedia of Chemical Technology (3^{rd} edition, Vol 8) provides a discussion of emulsions and provides a list of emulsifiers useful in the preparation of oil in water emulsions. Suitable examples are also set forth in U.S. Pat. Nos. 5,422,024, 5,417,869, 4,770,803 and 4,659,492. These patents are incorporated by reference herein in their entirety. In addition to the emulsifiers, the emulsifiable concentrate may include alkalinity buffers such as alkanolamines, rust/corrosion preventatives such as carboxylic/borated amine salts, alkanol amines, alkanol amide borates, lubricity additives such as esters, extreme pressure additives such as a chlorinated/sulfurized olefin or ester or sulfurized fatty materials, couplers such as fatty or other alcohols, biocides such as triazine or oxazolidene and optional functional additives such as defoamers, antioxidants, and/or metal passivators. For example, a commercially available concentrate is M3C99A (Chrysan Industries), which is a metalworking soluble oil concentrate.

(C) The Stable Metalworking Emulsifiable Concentrate Containing the Embedded Polymer

In the present invention, components (A) and (B) are combined to form a stable metalworking emulsifiable concentrate (C), which then is diluted with water, to form an end use oil-in-water emulsion (D) containing the embedded polymer.

The step of combining (A) and (B) can be in any form known that enables the combining of components (A) and (B) together to form a stable metalworking emulsifiable concentrate (C). It is preferred to combine (A) to (B) with stirring to completely mix the two components and form a stable metalworking emulsifiable concentrate (C). In this form, the polymer invert emulsion is stabilized in the oil continuous stable metalworking emulsifiable concentrate (C).

The composition of stable metalworking emulsifiable concentrate (C) comprises from about 0.1 wt % to about 40 wt % of component (A) added to about 99.9 wt % to about 60 wt % of component (B). Preferably, the composition of stable metalworking emulsifiable concentrate (C) comprises from about 1.0 wt % to about 6.0 wt % of component (A) added to about 99.0 wt % to about 94.0 wt % component (B).

The amount of component (A) in (C) is chosen based upon the total amount of polymer present in (A), adjusted to deliver a suitable polymer amount that imparts acceptable antimist performance to the end use emulsion (D).

(D) Formation of the Diluted End Use Emulsion Containing an Effective Amount of Polymer

The stable metalworking emulsifiable concentrate (C) comprising components (A) and (B) is then diluted and mixed with water, at the desired ratio, to obtain the diluted end use oil-in-water emulsion (D) having the polymer that imparts the desired antimist performance to the end use oil-in-water emulsion.

More specifically, the stable metalworking emulsifiable concentrate (C) is diluted and mixed with water in the range of about 0.1 wt % to about 50 wt % (C) in about 99.9 wt % to about 50.0 wt % water, preferably from about 2.5 wt % to about 20 wt % (C) in about 97.5 wt % to about 80.0 wt % water, most preferably about 5 wt % (C) in about 95 wt % water, to form the end use oil-in-water emulsion containing the polymer. The end use oil-in-water emulsion (D) is also referred to, throughout this specification, as the diluted end use emulsion.

The stable metalworking emulsifiable concentrate (C) can be shipped as is, and diluted by the end user to form the end use oil-in-water emulsion (D), or can be diluted to form the end use oil-in-water emulsion (D), before shipment to the end user.

The effective amount of polymer that is delivered to the end use emulsion upon dilution of (C) with water is determined by the wt % polymer in (A), by the amount of (A) in (C), and by the dilution ratio of the emulsifiable concentrate (C) in water used to form the end use emulsion.

As an illustrative example, if component (A) contains 30% polymer, the emulsifable concentrate (C) contains 3% of component (A)+97% of component (B), then the effective amount of polymer delivered to the MWF upon 5% dilution of (C) with water is determined by the following calculation:

5% of (3% (A)+97% B) [symbol] 5% (3% of 30% polymer)=0.045% polymer 450 ppm polymer

The same calculation steps can be used to show that when (A) equals from about 0.1 wt % to about 50 wt % polymer in the dispersed phase; (B) equals from about 99 wt % to about 1.0 wt % emulsifier package plus about 1.0 wt % to about 99 wt % oil; C equals from about 0.1 wt % to about 40 wt % (A) plus from about 99.9 wt % to about 60 wt % (B), and D equals from about 0.1 wt % to about 50.0 wt % (C) plus from about 99.9 wt % to about 50.0 wt % water, the amount of active polymer according to the present invention delivered to the end use emulsion (D) ranges from about 0.001 ppm to about 100,000 ppm. Preferably, the amount of active polymer according to the present invention delivered to the end use emulsion (D) ranges from about 150 to about 1000 ppm, imparting antimist performance accordingly.

Likewise, the amount of emulsifier in the diluted end use emulsion is determined by the amount of active emulsifier in component (B), by the amount of component (B) in the emulsifiable concentrate (C), and by the amount of dilution with water to form the oil-in-water emulsion, (D).

Example of Incorporating the Polymer and Its Use

The following Example 3 illustrates the method of incorporating an effective amount of polymer into a metalworking emulsifiable concentrate, to form a stable metalworking emulsifiable concentrate (C). Its use to impart antimist performance in the resultant oil-in-water emulsion (D) according to the present invention is shown in Tables 1 and 2, and in Example 3, below.

### EXAMPLE 3

Component (A), LZ Sample #1, containing about 30 wt % polymer, was added at 1% to 6% to a well stirred component (B), to form emulsifiable concentrate (C).

The stability of (C) was determined by storage at 70° C. for 12 hours. The samples were stable as indicated by visual inspection of each, showing no polymer dropout, no insolubles, no phase separation, no gellation, and no haziness. Other emulsifiable concentrates (C) were formed in the same way as described here.

Each of these emulsifiable concentrates (C), made by mixing components (A) and (B), as described above, are listed in Table 1. Each of the 5 samples listed in Table 1 were kept for approximately 12 hours in a lab oven at 70° C. to determine their stability. Stable samples were obtained for concentrates listed in Table 1.

TABLE 1
Stable emulsifiable concentrates (C) with embedded polymer

| | | | Stable | |
|---|---|---|---|---|
| Item | Concentrate | Emulsifiable | emulsifiable | |
| # | (A) | Concentrate (B) | Concentrate (C) | Stability |
| 1 | Nalcotrol ® | M3C99A (Chrysan) | 1 wt % (A) + | Stable* |
| | (30% polymer) | | 99 wt % (B) | |
| 2 | Nalcotrol ® | M3C99A (Chrysan) | 2 wt % (A) + | Stable* |
| | (30% polymer) | | 98 wt % (B) | |
| 3 | Nalcotrol ® | M3C99A (Chrysan) | 3 wt % (A) + | Stable* |
| | (30% polymer) | | 97 wt % (B) | |
| 4 | LZ Sample #1 | M3C99A (Chrysan) | 6 wt % (A) + | Stable* |
| | (30% polymer) | | 94 wt % (B) | |
| 5 | LZ Sample #2 | M3C99A (Chrysan) | 3 wt % (A) + | Stable* |
| | (30% polymer) | | 97 wt % (B) | |

*Stability criteria: No polymer dropout, insolubles (fisheyes), phase separation, gellation or haziness

Grinder Antimist Test

The grinder antimist test is used to measure the antimist performance exhibited (achieved) by the diluted end use oil-in-water emulsion (D) of the present invention.

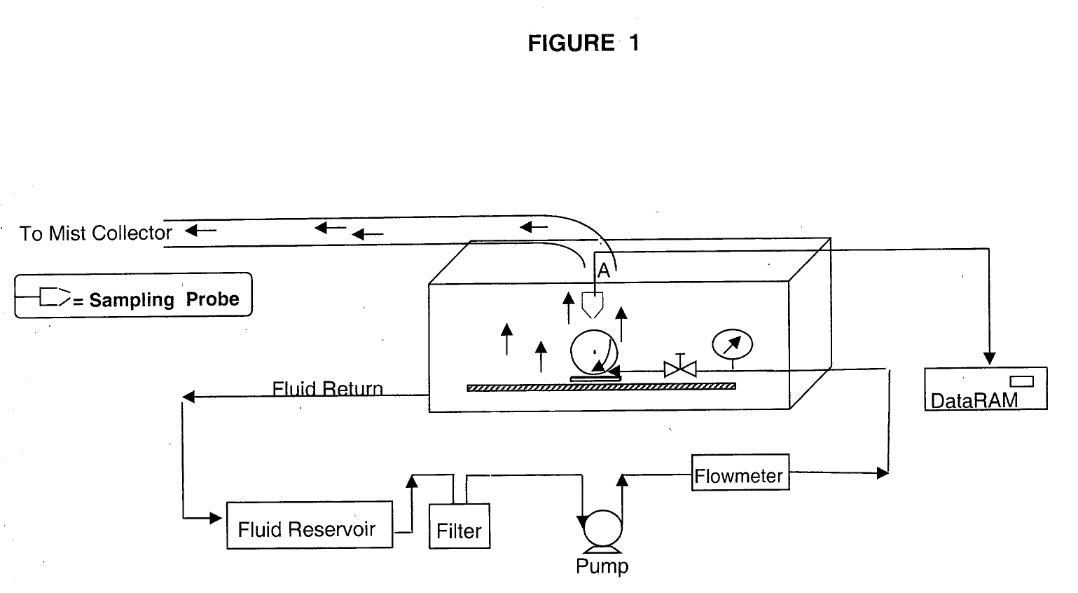

The grinder antimist test used to measure antimist performance provided by the polymers used according to the present invention consists of a partially enclosed Boyar Schulz surface grinder, in which a 6″ W×1/2″ thick resin bonded medium grit wheel is used to machine a 1018 steel bar (1″×1″×6″) at 3000 rpm. A gear pump is used to recirculate the diluted end use emulsion in the system and feed the emulsion from a 5 gallon capacity sump to the workpiece/grinding wheel interface at approximately 2 gpm flow rate and 80 psi pressure through a 1/8″ nozzle. The grinding wheel/workpiece is enclosed within a 1.2 ft³ plexiglas enclosure to capture and localize the mists produced during grinding as shown in FIG. 1.

A portable, real time aerosol monitor DataRAM® [MIE Instruments Inc., Bedford Mass.] was used to continuously quantify the mist levels generated from the diluted end use emulsion inside the grinder enclosure as shown in FIG. 1. End use emulsion prepared from the emulsifiable concentrate without the polymer was first used to establish baseline mist levels. The DataRAM is a nephelometric monitor used to measure airborne particle concentration by sensing the amount of light scattered by the population of particles passing through a sampling volume. During its operation, a discrete amount of air volume (@2 liters/minute) is illuminated by a pulsed light emitting diode with the narrow band at 880 nm. The concentration of airborne particulate is then measured based upon the response of a silicon detector hybrid amplifier unit to the forward-scattered light intensity. The DataRAM provides concentration measurement ranges from 0.0001 mg/m³ to 400 mg/m³ (as Arizona dust primary standard calibration).

The air sampling in the grinder experiment was done under stagnant conditions so as to exaggerate and maximize the mist concentrations in the enclosure. The sampling probe was set at a height of 5.5′ in the enclosure as shown in FIG. 1. An end use emulsion prepared from an emulsifiable concentrate without any polymer was first used to establish a baseline. Each grinding experiment was started with ambient sampling to establish background air quality. This was followed by the idling cycle where the recirculating diluted end use emulsion was sprayed on the revolving wheel/steel workpiece interface for 15 minutes [Step A]. Following the idling cycle, grinding was initiated in which the steel piece surface was machined in incremental sweeps of 0.001″ for a period of 30 minutes [Step B]. The sequence of steps A and B was repeated twice with the end use emulsion (without the polymer) to establish baseline mist levels.

After establishing baseline mist levels, the grinder sump was charged with an end use emulsion (D) according to the present invention prepared from a stable metalworking emulsifiable concentrate (C) according to the present invention, containing the polymer useful in the present invention.

The sequence of ambient air sampling of idling and grinding steps A and B, as described above, was again repeated under identical grinding and mist sampling conditions as used for the baseline. The mist reduction performance derived from the polymers present in the candidate end use emulsions was calculated by comparing mist levels generated by the baseline emulsions prepared from emulsifiable concentrate without the polymer with those containing the embedded polymer, derived from emulsifiable concentrate (C). The results are listed in Table 2. Table 2 indicates that emulsifiable concentrate (C) is diluted at 20:1 dilution (5% in water), to form end use emulsion (D), having the indicated mist reduction performance listed in Table 2.

More specifically, the M3C99A emulsifiable concentrate (baseline) and the M3C99A emulsifiable concentrate with embedded 1% Nalcotrol®, were each diluted at 5% in water and their misting tendency was compared in the grinder antimist test.

It was found that the baseline end use emulsion (without polymer) at 20:1 (5%) dilution generated an average of 14.86±1.02 mg/m³ mist inside the enclosure (as shown in FIG. 1) during grinding.

Under similar grinding conditions, a 5% emulsion prepared from emulsifiable concentrate (C) with 1% embedded concentrate (A) (Nalcotrol®, 30% polymer) which delivered 150 ppm active polymer to the diluted end use emulsion, (D), generated an average of 8.56±0.56 mg/m³ mist inside the enclosure during grinding.

The amount of mist reduction (% antimist or % mist reduction) performance derived from emulsifiable concentrate (C) which is achieved (exhibited) by diluted end use emulsion(D) is calculated as follows:

$$\text{\% mist reduction} = \frac{\begin{matrix}\text{mist} ( mg / {m}^{3} ) \text{generated during} \\ \text{grinding (candidate emulsion with polymer)}\end{matrix}}{\begin{matrix}\text{mist} ( mg / {m}^{3} ) \text{generated during grinding} \\ \text{(baseline emulsion without polymer)}\end{matrix}} \times 100$$

Therefore, % mist reduction measured for the diluted end use emulsion (D) containing 1% Nalcotrol® embedded in M3C99A=8.56/14.86×100=58% mist reduction (Item 1, Table 2).

Similarly, emulsions prepared from concentrates type (C) with LZ Sample #2 (item 2 and item 3 in Table 2) delivered 78% and 58% mist reduction over the baseline M3C99A at 900 ppm and 450 ppm active polymer treat rate, respectively, demonstrating the antimist effectiveness of these polymers.

TABLE 2
Measured mist reduction performance of emulsifiable concentrates with
embedded polymer

| | Emulsifiable concentrate | Active polymer @ | % Mist |
|---|---|---|---|
| Item # | (C) | 20:1 dilution | Reduction |
| 1 | 1 wt % (A) + 99 wt % (B) | 150 ppm | 58% |
| 2 | 6 wt % (A) + 94 wt % (B) | 900 ppm | 78% |
| 3 | 3 wt % (A) + 97 wt % (B) | 450 ppm | 58% |

The effective amount of antimist performance achieved by the end use oil-in-water emulsion of the present invention is from about 5% to 100% mist reduction, preferably from about 40% to 100% mist reduction, as measured according to the grinder antimist test.

It should be understood that the forms of the invention described herein are exemplary only and are not intended as limitations on the scope of the present invention as defined in the appended claims.

What is claimed is:

1. A method of incorporating at least one water soluble or water dispersible polymer into a metalworking emulsifiable concentrate, comprising:
utilizing a polymer invert emulsion containing said water soluble or water dispersible polymer in a dispersed aqueous phase.

2. The method of claim 1, wherein said water soluble or water dispersible polymer is selected from the group consisting of at least one of homopolymers, copolymers, and higher interpolymers, or a combination thereof, made from at least one monomer which is at least partially soluble in water.

3. The method of claim 2, wherein said water soluble or water dispersible polymer is stable in said metalworking emulsifiable concentrate, and imparts antimist performance to an end use oil-in-water emulsion as measured by a grinder antimist test.

4. The method of claim 1, wherein said water soluble or water dispersible polymer is selected from the group consisting of at least one of homopolymers, copolymers, and higher interpolymers, or a combination thereof, made from at least one acrylic monomer which is at least partially soluble in water.

5. The method of claim 4, wherein said water soluble or water dispersible polymer is stable in said metalworking emulsifiable concentrate and imparts antimist performance to an end use oil-in-water emulsion as measured by a grinder antimist test.

6. The method of claim 2, wherein said at least one monomer is selected from the group consisting of acrylamide, methacrylamide, maleic anhydride, 3-acrylamido-3-methylbutyltrimethylammonium chloride, 2-acrylamido-2-methylpropyl trimethylammonium chloride, 2-methacryloyloxyethyl trimethylammonium metho-sulfate, 3-methacryloyl-2-hydroxypropyl trimethylammonium chloride, dimethyldiallyl-ammonium chloride, diethyldiallylammonium chloride, -vinyl acetate, N-vinyl-pyrrolidone, polyethyleneglycol monomethacrylate, acrylic acid or an amine or metal salt thereof, methacrylic acid or an amine or metal salt thereof, fumaric acid or an amine or metal salt thereof, maleic acid or an amine or metal salt thereof, crotonic acid or an amine or metal salt thereof, itaconic acid or an amine or metal salt thereof, and 3-acrylamido-3-methylbutanoic acid or an amine or metal salt thereof.

7. The method of claim 4, wherein said acrylic monomer is selected from the group consisting of acrylic acids, esters of acrylic acids, amine or metal salts of acrylic acids, acrylic amides, and acrylonitriles and the corresponding alkacryl- and methacryl-compounds.

8. The method of claim 7, wherein said esters of acrylic or methacrylic acids contain from 1 to about 50 carbon atoms in an ester group.

9. The method of claim 8, wherein said ester groups are lower alkyl esters having fewer than 8 carbon atoms, preferably from 1 to about 4 carbon atoms.

10. The method of claim 2, wherein said monomer is a sulfonic acid, or an amine or metal salt thereof, selected from the group consisting of 2-acrylamido-2-methylpropanesulfonic acid, styrene sulfonic acid, vinylsulfonic acid, allylsulfonic acid, and methallylsulfonic acid.

11. The method of claim 2, wherein said monomer is a sulfoalkyl ester selected from the group consisting of 2-sulfoethylmethacrylate, 3-sulfopropyl acrylate, and 3-sulfopropylmethacrylate.

12. The method of claim 2, wherein said monomer is a phosphonic acid or amine or metal salt or ester thereof, selected from the group consisting of 2-acrylamido-2-methylpropanephosphonic acid, phosphonomethylacrylate, phosphono-methyl methacrylate, vinyl phosphonic acid, and allyl phosphonic acid.

13. The method of claim 6, 7, 10, 11, or 12, further comprising at least one additional monomer selected from the group consisting of vinyl aromatic monomers, polymerizable olefin monomers, alkyl acrylates, alkyl methacrylates, dialkyl fumarates, dialkyl maleates and their corresponding half esters, maleamic esters, maleimides, vinyl esters of C₁ to C₁₂ carboxylic acids, and allyl carboxylates.

14. The method of claim 1, wherein said water soluble or water dispersible polymer is made from copolymerization of acrylamide and 2-acrylamido-2-methylpropanesulfonic acid or metal salts thereof.

15. The method of claim 1, wherein said water soluble or water dispersible polymer is contained in said polymer invert emulsion in an amount from about 0.1 wt % to about 50 wt %, based upon the total weight of said polymer invert emulsion.

16. The method of claim 1, wherein said water soluble or water dispersible polymer is contained in said polymer invert emulsion in an amount from about 10 wt % to about 35 wt %, based upon the total weight of said polymer invert emulsion.

17. The method of claim 1, wherein said metalworking emulsifiable concentrate is a combination of about 1.0 wt % to about 99 wt % of a base oil and about 99 wt % to about 1.0 wt % of an emulsifier package.

18. The method of claim 1, wherein said polymer invert emulsion is combined with said metalworking emulsifiable concentrate, to form a stable metalworking emulsifiable concentrate containing said water soluble or water dispersible polymer.

19. The method of claim 18, wherein said stable metalworking emulsifiable concentrate comprises from about 0.1% to about 40.0% of said polymer invert emulsion and from about 99.9% to about 60.0% of said metalworking emulsifiable concentrate.

20. The method of claim 18, wherein said polymer invert emulsion is combined with said metalworking emulsifiable concentrate in an amount from about 0.1 wt % to about 40 wt %, and said metalworking emulsifiable concentrate is combined with said polymer invert emulsion in an amount from about 99.9 wt % to about 60 wt %, based upon the total weight of said stable metalworking emulsifiable concentrate.

21. The method of claim 18, wherein said polymer invert emulsion is combined with said metalworking emulsifiable concentrate in an amount from about 1.0 wt % to about 6.0 wt %, and said metalworking emulsifiable concentrate is combined with said polymer invert emulsion in an amount from about 99.0 wt % to about 94.0 wt %, based upon the total weight of said stable metalworking emulsifiable concentrate.

22. The method of claim 18, wherein said stable metalworking emulsifiable concentrate is diluted with water in an amount of about 0.1% to about 50% metalworking emulsifiable concentrate to about 99.9% to about 50.0% water, to form an end use oil-in-water emulsion exhibiting an effective amount of antimist performance.

23. The method of claim 18, wherein said stable metalworking emulsifiable concentrate is diluted with water in an amount of about 2.5 wt % to about 20 wt % metalworking emulsifiable concentrate to about 97.5 wt % to about 80.0 wt % water, to form an end use oil-in-water emulsion exhibiting an effective amount of antimist performance.

24. The method of claim 18, wherein said stable metalworking emulsifiable concentrate is diluted with water in an amount of about 5 wt % metalworking emulsifiable concentrate to about 95 wt % water, to form an end use oil-in-water emulsion exhibiting an effective amount of antimist performance.

25. The method of claim 20, wherein, upon dilution with said water, an effective amount of said water-soluble or water-dispersible polymer is delivered to said end use oil-in-water emulsion, imparting an effective amount of antimist performance.

26. The method of claim 25, wherein said effective amount of said water-soluble or water-dispersible polymer is from about 0.001 ppm to about 100,000 ppm, based upon the total weight of said end use oil-in-water emulsion.

27. The method of claim 25, wherein said effective amount of said water-soluble or water-dispersible polymer is from about 150 ppm to about 1000 ppm, based upon the total weight of said end use oil-in-water emulsion.

28. The method of claim 25, wherein said effective amount of antimist performance is from about 5.0% to 100% mist reduction as measured by a grinder antimist test.

29. The method of claim 25, wherein said effective amount of antimist performance is from about 40.0% to 100% mist reduction as measured by a grinder antimist test.

30. An end use oil-in-water emulsion made according to the method of claim 22.

31. A method of using a polymer invert emulsion containing a water soluble or water dispersible polymer in the dispersed aqueous phase, comprising:
incorporating at least one water-soluble or water-dispersible polymer into a metalworking emulsifiable concentrate by combining said polymer invert emulsion with said metalworking emulsifiable concentrate to form a stable metalworking emulsifiable concentrate.

32. The method of using a polymer invert emulsion according to claim 31, wherein said stable metalworking emulsifiable concentrate is diluted with water in an amount of about 0.1 wt % to about 50 wt % metalworking emulsifiable concentrate to about 99.9 wt % to about 50.0 wt % water, to form an end use oil-in-water emulsion exhibiting an effective amount of antimist performance.

33. The method of using of claim 32, wherein, upon dilution with water, an effective amount of said water-soluble or water-dispersible polymer delivers an effective amount of antimist performance to said end use oil-in-water emulsion.

34. The method of using of claim 33, wherein said effective amount of antimist performance is from about 5.0% to 100% mist reduction.

35. The method of using of claim 33, wherein said effective amount of antimist performance is from about 40.0% to 100% mist reduction.

36. A method of imparting antimist performance to a metalworking emulsifiable concentrate, comprising:
incorporating at least one water-soluble or water-dispersible polymer into said metalworking emulsifiable concentrate by combining a polymer invert emulsion containing said water soluble or water dispersible polymer with a metalworking emulsifiable concentrate, followed by dilution with water.

37. A stable metalworking emulsifiable concentrate comprising a blend of a polymer invert emulsion containing a water soluble or water dispersible polymer and a metalworking emulsifiable concentrate.

38. The stable metalworking emulsifiable concentrate of claim 37, wherein said water soluble or water dispersible polymer is selected from the group consisting of at least one of homopolymers, copolymers, and higher interpolymers, or a combination thereof, made from at least one monomer which is at least partially soluble in water.

39. The stable metalworking emulsifiable concentrate of claim 38, wherein said water soluble or water dispersible polymer is stable in said metalworking emulsifiable concentrate, and imparts antimist performance as measured by a grinder antimist test to an end use oil-in-water upon dilution of said stable metalworking emulsifiable concentrate.

40. The stable metalworking emulsifiable concentrate of claim 37, wherein said water soluble or water dispersible polymer is selected from the group consisting of at least one of homopolymers, copolymers, and higher interpolymers, or a combination thereof, made from at least one acrylic monomer which is at least partially soluble in water, and which imparts antimist performance to said metalworking emulsifiable concentrate.

41. The stable metalworking emulsifiable concentrate of claim 40, wherein said water soluble or water dispersible polymer is stable in said metalworking emulsifiable concentrate, and imparts antimist performance as measured by a grinder antimist test to an end use oil-in-water emulsion upon dilution of said stable metalworking emulsifiable concentrate.

42. The stable metalworking emulsifiable concentrate of claim 38, wherein said at least one monomer is selected from the group consisting of acrylamide, methacrylamide, maleic anhydride, 3-acrylamido-3-methylbutyltrimethylammonium chloride, 2-acrylamido-2-methylpropyl trimethylammonium chloride, 2-methacryloyl-oxyethyl trimethylammonium methosulfate, 3-methacryloyl-2-hydroxypropyl trimethyl-ammonium chloride, dimethyldiallylammonium chloride, diethyldiallylammonium chloride, vinyl acetate, N-vinylpyrrolidone, polyethyleneglycol monomethacrylate, acrylic acid or an amine or metal salt thereof, methacrylic acid or an amine or metal salt thereof, fumaric acid or an amine or metal salt thereof, maleic acid or an amine or metal salt thereof, crotonic acid or an amine or metal salt thereof, itaconic acid or an amine or metal salt thereof, and 3-acrylamido-3-methylbutanoic acid or an amine or metal salt thereof.

43. The stable metalworking emulsifiable concentrate of claim 40, wherein said acrylic monomer is selected from the group consisting of acrylic acids, esters of acrylic acids, amine or metal salts of acrylic acids, acrylic amides, and acrylonitriles and the corresponding alkacryl- and methacryl-compounds.

44. The stable metalworking emulsifiable concentrate of claim 43, wherein said esters of acrylic or methacrylic acids contain from 1 to about 50 carbon atoms in an ester group.

45. The stable metalworking emulsifiable concentrate of claim 43, wherein said ester groups are lower alkyl esters having fewer than 8 carbon atoms, preferably from 1 to about 4 carbon atoms.

46. The stable metalworking emulsifiable concentrate of claim 38, wherein said monomer is a sulfonic acid, or an amine or metal salt thereof, selected from the group consisting of 2-acrylamido-2-methylpropanesulfonic acid, styrene sulfonic acid, vinylsulfonic acid, allylsulfonic acid, and methallylsulfonic acid.

47. The stable metalworking emulsifiable concentrate of claim 38, wherein said monomer is a sulfoalkyl ester selected from the group consisting of 2-sulfoethylmethacrylate, 3-sulfopropyl acrylate, and 3-sulfopropylmethacrylate.

48. The stable metalworking emulsifiable concentrate of claim 38, wherein said monomer is a phosphonic acid or amine or metal salt or ester thereof, selected from the group consisting of 2-acrylamido-2-methylpropanephosphonic acid, phosphonomethylacrylate, phosphonomethyl methacrylate, vinyl phosphonic acid, and allyl phosphonic acid.

49. The stable metalworking emulsifiable concentrate of claim 42, 43, 46, 47, or 48, further comprising at least one additional monomer selected from the group consisting of vinyl aromatic monomers, polymerizable olefin monomers, alkyl acrylates, alkyl methacrylates, dialkyl fumarates, dialkyl maleates and their corresponding half esters, maleamic esters, maleimides, vinyl esters of C₁ to C₁₂ carboxylic acids, and allyl carboxylates.

50. The stable metalworking emulsifiable concentrate of claim 37, wherein said water soluble or water dispersible polymer is made from copolymerization of acrylamide and 2-acrylamido-2-methylpropanesulfonic acid or metal salts thereof.

51. The stable metalworking emulsifiable concentrate of claim 37, wherein said water soluble or water dispersible polymer is contained in said polymer invert emulsion in an amount from about 0.1 wt % to about 50 wt %, based upon the total weight of said polymer invert emulsion.

52. The stable metalworking emulsifiable concentrate of claim 37, wherein said water soluble or water dispersible polymer is contained in said polymer invert emulsion in an amount from about 10 wt % to about 35 wt %, based upon the total weight of said polymer invert emulsion.

53. The stable metalworking emulsifiable concentrate of claim 37, wherein said metalworking emulsifiable concentrate is a combination of about 1.0 wt % to about 99 wt % of a base oil and about 99 wt % to about 1.0 wt % of an emulsifier package.

54. The stable metalworking emulsifiable concentrate of claim 37, wherein said polymer invert emulsion is contained in said blend in an amount from about 0.1 wt % to about 40 wt %, and said metalworking emulsifiable concentrate is contained in said blend in an amount from about 99.9 wt % to about 60 wt %, based upon the total weight of said blend.

55. The stable metalworking emulsifiable concentrate of claim 37, wherein said polymer invert emulsion is contained in said blend in an amount from about 1.0 wt % to about 6.0 wt %, and said metalworking emulsifiable concentrate is contained in said blend in an amount from about 99.0 wt % to about 94.0 wt %, based upon the total weight of said blend.

56. An end use oil-in-water emulsion comprising a blend of a polymer invert emulsion containing a water soluble or water dispersible polymer and a metalworking emulsifiable concentrate, wherein said blend is diluted with water.

57. The end use oil-in-water emulsion of claim 56, wherein said water soluble or water dispersible polymer is selected from the group consisting of at least one of homopolymers, copolymers, and higher interpolymers, or a combination thereof, made from at least one monomer which is at least partially soluble in water.

58. The end use oil-in-water emulsion of claim 57, wherein said water soluble or water dispersible polymer imparts antimist performance to said end use oil-in-water emulsion as measured by a grinder antimist test.

59. The end use oil-in-water emulsion of claim 56, wherein said water soluble or water dispersible polymer is selected from the group consisting of at least one of homopolymers, copolymers, and higher interpolymers, or a combination thereof, made from at least one acrylic monomer which is at least partially soluble in water, and which imparts antimist performance to said metalworking emulsifiable concentrate.

60. The end use oil-in-water emulsion of claim 59, wherein said water soluble or water dispersible polymer imparts antimist performance to said end use oil-in-water emulsion as measured by a grinder antimist test.

61. The end use oil-in-water emulsion of claim 57, wherein said at least one monomer is selected from the group consisting of acrylamide, methacrylamide, maleic anhydride, 3-acrylamido-3-methylbutyltrimethylammonium chloride, 2-acrylamido-2-methylpropyl trimethylammonium chloride, 2-methacryloyloxyethyl trimethyl-ammonium methosulfate, 3-methacryloyl-2-hydroxypropyl trimethylammonium chloride, dimethyldiallylammonium chloride, diethyldiallylammonium chloride, vinyl acetate, N-vinylpyrrolidone, polyethyleneglycol monomethacrylate, acrylic acid or an amine or metal salt thereof, methacrylic acid or an amine or metal salt thereof, fumaric acid or an amine or metal salt thereof, maleic acid or an amine or metal salt thereof, crotonic acid or an amine or metal salt thereof, itaconic acid or an amine or metal salt thereof, and 3-acrylamido-3-methylbutanoic acid or an amine or metal salt thereof.

62. The end use oil-in-water emulsion of claim 59, wherein said acrylic monomer is selected from the group consisting of acrylic acids, esters of acrylic acids, amine or metal salts of acrylic acids, acrylic amides, and acrylonitriles and the corresponding alkacryl- and methacryl-compounds.

63. The end use oil-in-water emulsion of claim 62, wherein said esters of acrylic or methacrylic acids contain from 1 to about 50 carbon atoms in an ester group.

64. The end use oil-in-water emulsion of claim 63, wherein said ester groups are lower alkyl esters having fewer than 8 carbon atoms, preferably from 1 to about 4 carbon atoms.

65. The end use oil-in-water emulsion of claim 57, wherein said monomer is a sulfonic acid, or an amine or metal salt thereof, selected from the group consisting of 2-acrylamido-2-methylpropanesulfonic acid, styrene sulfonic acid, vinylsulfonic acid, allylsulfonic acid, and methallylsulfonic acid.

66. The end use oil-in-water emulsion of claim 57, wherein said monomer is a sulfoalkyl ester selected from the group consisting of 2-sulfoethylmethacrylate, 3-sulfopropyl acrylate, and 3-sulfopropylmethacrylate.

67. The end use oil-in-water emulsion of claim 57, wherein said monomer is a phosphonic acid or amine or metal salt or ester thereof, selected from the group consisting of 2-acrylamido-2-methylpropanephosphonic acid, phosphonomethyl-acrylate, phosphonomethyl methacrylate, vinyl phosphonic acid, and allyl phosphonic acid.

68. The end use oil-in-water emulsion of claim 61, 62, 65, 66, or 67, further comprising at least one additional monomer selected from the group consisting of vinyl aromatic monomers, polymerizable olefin monomers, alkyl acrylates, alkyl methacrylates, dialkyl fumarates, dialkyl maleates and their corresponding half esters, maleamic esters, maleimides, vinyl esters of C, to C₁₂ carboxylic acids, and allyl carboxylates.

69. The end use oil-in-water emulsion of claim 56, wherein said water soluble or water dispersible polymer is made from copolymerization of acrylamide and 2-acrylamido-2-methylpropanesulfonic acid or metal salts thereof.

70. The end use oil-in-water emulsion of claim 56, wherein said water soluble or water dispersible polymer is contained in said polymer invert emulsion in an amount from about 0.1 wt % to about 50 wt %, based upon the total weight of said polymer invert emulsion.

71. The end use oil-in-water emulsion of claim 56, wherein said water soluble or water dispersible polymer is contained in said polymer invert emulsion in an amount from about 10 wt % to about 35 wt %, based upon the total weight of said polymer invert emulsion.

72. The end use oil-in-water emulsion of claim 56, wherein said metalworking emulsifiable concentrate is a combination of about 1.0 wt % to about 99 wt % of a base oil and about 99 wt % to about 1.0 wt % of an emulsifier package.

73. The end use oil-in-water emulsion of claim 56, wherein said polymer invert emulsion is contained in said blend in an amount from about 0.1 wt % to about 40 wt %, and said metalworking emulsifiable concentrate is contained in said blend in an amount from about 99.9 wt % to about 60 wt %, based upon the total weight of said blend.

74. The end use oil-in-water emulsion of claim 56, wherein said polymer invert emulsion is contained in said blend in an amount from about 1.0 wt % to about 6.0 wt %, and said metalworking emulsifiable concentrate is contained in said blend in an amount from about 99.0 wt % to about 94.0 wt %, based upon the total weight of said blend.

75. The end use oil-in-water emulsion of claim 56, wherein said end use oil-in-water emulsion exhibits an effective amount of antimist performance of from about 5.0% to 100% mist reduction as measured by a grinder antimist test.

76. The end use oil-in-water emulsion of claim 56, wherein said end use oil-in-water emulsion exhibits an effective amount of antimist performance of from about 40.0% to 100% mist reduction as measured by a grinder antimist test.

77. A method of using said end use oil-in-water emulsion of claim 52, comprising:
utilizing said end use oil-in-water emulsion during metalworking operations.
